(19) United States
(12) Patent Application Publication
(10) Pub. No.: US 2013/0346204 A1
(43) Pub. Date: Dec. 26, 2013

(54) In-Store Guidance Systems and Methods

(71) Applicants: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(72) Inventors: Alexander D. Wissner-Gross, Cambridge, MA (US); Timothy M. Sullivan, Murray, UT (US); Robert J. Wolf, Sandy, UT (US); Robert V. Brazell, Salt Lake City, UT (US)

(21) Appl. No.: 13/710,204

(22) Filed: Dec. 10, 2012

Related U.S. Application Data
(60) Provisional application No. 61/569,111, filed on Dec. 9, 2011.

(51) Int. Cl. G06Q 30/02

(52) U.S. Cl. CPC G06Q 30/0281
USPC 705/14.58; 705/323; 705/26.8; 705/14.66

(57) ABSTRACT

The present invention is directed to providing a map of a retail store to guide a customer in the retail store. A map can be displayed in a user interface on a customer's computing device such as a smart phone. The customer can provide input to the user interface that requests assistance in locating one or more products in the store. The user interface can update the map to provide the requested assistance.

### CROSS-REFERENCE TO RELATED APPLICATIONS

This application claims priority to U.S. Provisional Patent Application Ser. No.: 61/569,111 which was filed on Dec. 9, 2011 and titled “In-Store Guidance Systems And Methods.”

### BACKGROUND

When shopping, many consumers have trouble finding the right products and choosing between competing products. Currently, consumers must walk through stores, occasionally guided by store employees, looking at in-store signs to guide themselves to the products that they want. Once they find a product or group of similar products, the consumer may need to read product information from product tags or labels or talk with a store employee to learn more about the particular products.

Occasionally, products are advertised in stores in ways that inform the consumer about the particular product. In-store advertisements are generally designed to inform consumers about specific products and entice consumers to purchase those products. Despite the potential effectiveness of current in-store advertising systems, such advertisements generally include only one advertising approach that may not effectively address the needs of many types of consumers or provide certain consumers with the type of information that is most effective to entice each consumer to purchase the advertised product.

### BRIEF SUMMARY

The present invention extends to methods, systems, and computer program products for providing a map of a retail store to guide a customer in the retail store. A map can be displayed in a user interface on a customer's computing device such as a smart phone. The customer can provide input to the user interface that requests assistance in locating one or more products in the store. The user interface can update the map to provide the requested assistance.

In one embodiment, the present invention provides a method for providing a map of a retail store to guide a customer in the retail store. It is determined that a customer is located at a retail store. A map of the retail store is generated. The map of the retail store is displayed to the customer. Input is received from the customer that requests the location of a product within the retail store. The map is updated to identify the location of the product within the retail store.

In another embodiment, the present invention provides a method for providing a map of a retail store to a portable computing device carried by a customer at the retail store. It is detected that a portable computing device carried by a customer is located at a retail store. A map of the retail store is sent to the portable computing device for display to the customer. Customer input is received, from the portable computing device. The customer input requests the location of a product within the retail store. The map is updated to identify the location of the product within the retail store. The updated map is then provided to the portable computing device for display to the customer.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary environment in which the present invention can be implemented;

FIGS. 2A-2C illustrate an exemplary customer computing device that provides a user interface for displaying a map of a retail store;

FIG. 3 illustrates a plurality of displays on a shelf that can be updated in response to detecting the presence of a customer computing device;

FIG. 4 illustrates an exemplary method for providing a map of a retail store to guide a customer in the retail store; and

FIG. 5 illustrates an exemplary method for providing a map of a retail store to a portable computing device carried by a customer at the retail store.

### DETAILED DESCRIPTION

The present invention extends to methods, systems, and computer program products for providing a map of a retail store to guide a customer in the retail store. A map can be displayed in a user interface on a customer's computing device such as a smart phone. The customer can provide input to the user interface that requests assistance in locating one or more products in the store. The user interface can update the map to provide the requested assistance.

In one embodiment, the present invention provides a method for providing a map of a retail store to guide a customer in the retail store. It is determined that a customer is located at a retail store. A map of the retail store is generated. The map of the retail store is displayed to the customer. Input is received from the customer that requests the location of a product within the retail store. The map is updated to identify the location of the product within the retail store.

In another embodiment, the present invention provides a method for providing a map of a retail store to a portable computing device carried by a customer at the retail store. It is detected that a portable computing device carried by a customer is located at a retail store. A map of the retail store is sent to the portable computing device for display to the customer. Customer input is received, from the portable computing device. The customer input requests the location of a product within the retail store. The map is updated to identify the location of the product within the retail store. The updated map is then provided to the portable computing device for display to the customer.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

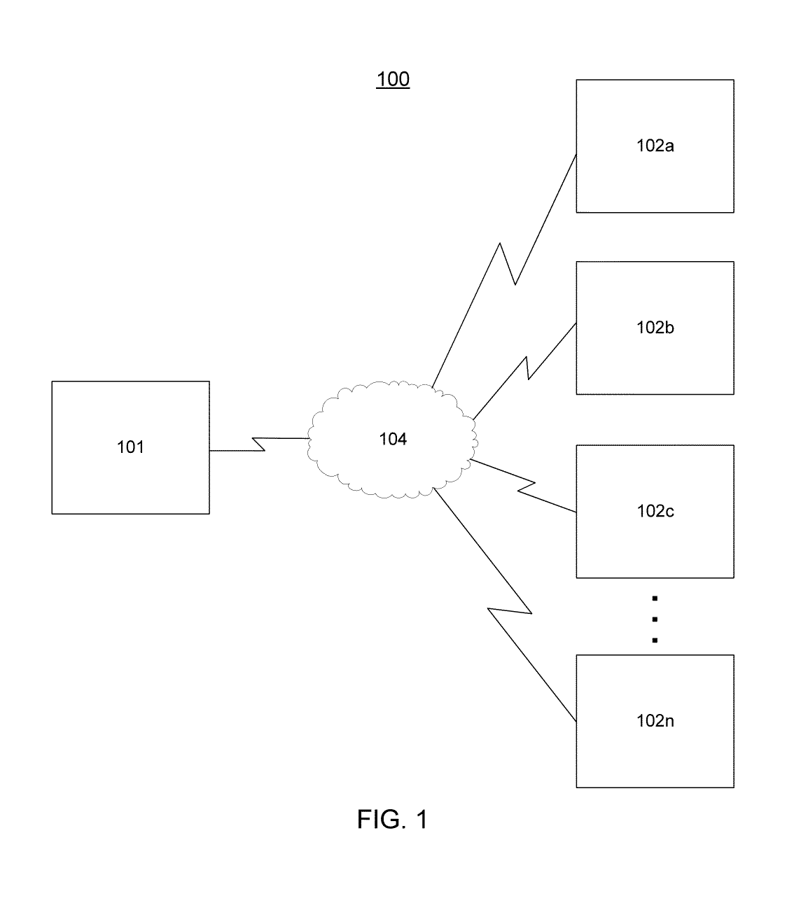

FIG. 1 illustrates an exemplary computer environment 100 in which the present invention can be implemented. Computer environment 100 includes server system 101, and customer computing devices 102a-102n. Customer computing devices 102a-102n can access content provided by server system 101 via network 103.

Server system 101 can comprise any number and type of computing devices or components. For example, server system 101 can comprise a single server device or a plurality of interconnected server components forming a cloud.

Customer computing devices 102a-102n can be any of various types of mobile devices that can display a user interface and communicate with (i.e. send information to and/or receive information from) server system 101 (e.g. via Wi-Fi, Bluetooth, NFC, RFID, etc.). For example, a customer computing device can be a tablet, smart phone, gaming device, etc.

Network 103 can represent various types of networks such as the internet, a local area network within a retail location, or any other type of network that allows content to be transferred from server system 101 to customer computing devices 102a-102n.

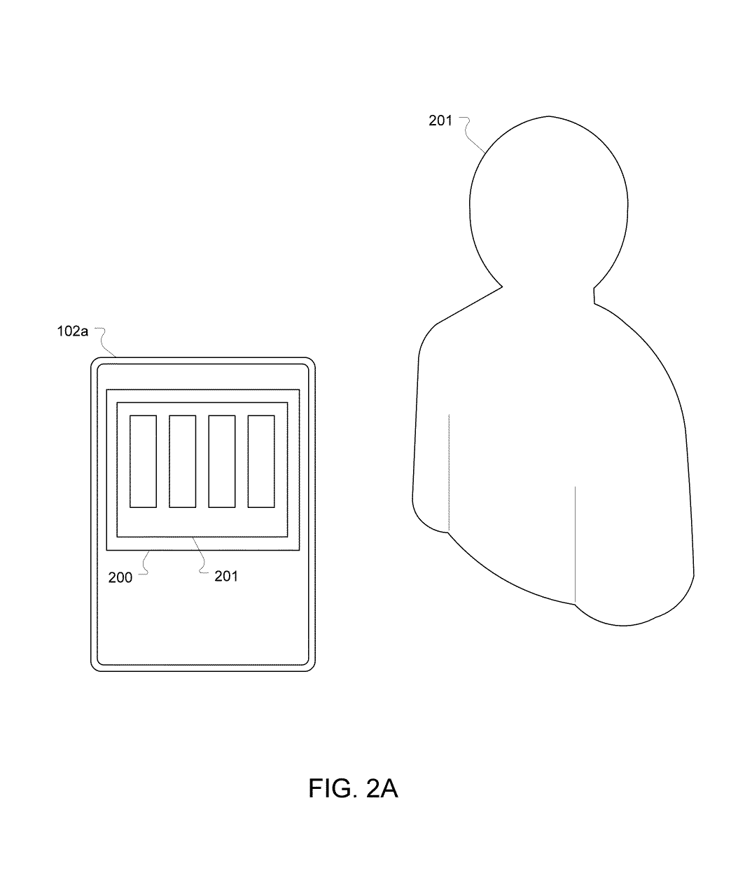

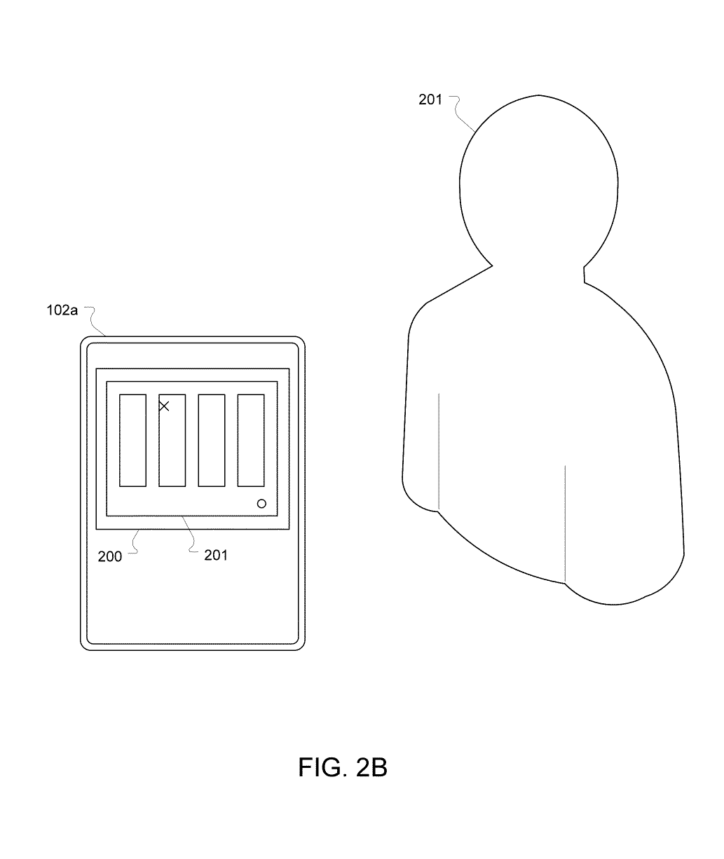

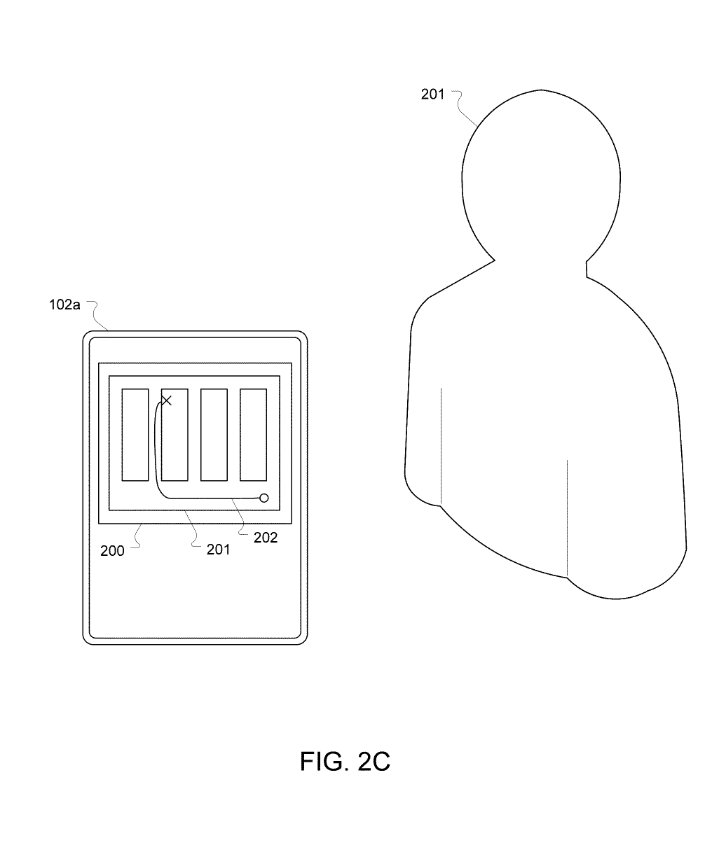

FIG. 2A illustrates an exemplary customer computing device 102a that provides a user interface 200 that can be displayed to a customer 201. User interface 200 can provide a store map service that can identify the location of a product within a store. The content displayed in user interface 200 can be generated by customer computing device 102a (e.g. using information received from server system 101, from customer 201, or from another source) or by server system 101. For example, user interface 200 can display a map 201 of a store layout that includes aisles, shelves, displays, checkouts, entries, exits, restrooms, and other store features. A store layout can also display different sections or departments of the store such as a produce section, a meat section, a freezer section, or other sections of a grocery store.

User interface 200 can provide different levels of detail regarding the location of a product within a store. For example, the user interface can identify the aisle where the product is located, or a specific location on the aisle. Additional product information can also be provided such as the type, size, or brand of the product. This information can be provided on the map or can be otherwise displayed or audibly output to the customer. FIG. 2B illustrates an example where the customer's current location is identified with a circle, and the location of a desired product is identified with an X.

In some embodiments, user interface 200 can also provide directions from the customer's current location to the location of a desired product. For example, as shown in FIG. 2C, the user interface can display a route 202 on the map to the location of the desired product. In some embodiments, the user interface can provide visual or audible directions.

In some embodiments, user interface 200 can provide a path through the store based on a shopping list submitted by the customer. In some embodiments, the path can be the most efficient route (e.g. the shortest distance or quickest route) through the store. The determination of the most efficient route can be based on factors such as high-traffic areas, physical structures such as stairs, escalators, or elevators, the location of restrooms, the location where the customer parked a car or will catch public transportation, etc.

In some embodiments, the user interface can present multiple potential paths to the user along with an estimated time for following each path. This estimation can be updated periodically or continuously based on the user pace or delays along the path.

In some embodiments, the calculation of a route can consider various product-specific factors such as whether any products need to remain hot or cold, or whether any products need to be placed at the top or bottom of the shopping cart. The user interface can also provide a cost for each product or a total cost for all products on the shopping list as well as recommendations for lowering the cost such as coupons or alternative products that are cheaper.

In some embodiments, the user interface can provide advertisements to the customer as the customer moves along the route. Because the user interface knows the route the customer will take as well as the type of products the user intends to purchase, the user interface can promote products along the planned route. These advertisements can be customized based on the customer's personal information, purchase history, products in the shopping list, or the estimated amount of money the customer will spend during the current shopping trip.

In some embodiments, the user interface can also identify which checkout line the customer should use to check out most quickly. Which checkout line is recommended can be based on historical or real-time data, the path through the store, or the exit the customer is likely to use.

In some embodiments, user interface 200 can use a compass in a customer computing device to determine which direction a customer is facing. This information can be used to determine which shelf a customer is looking at, whether the customer is looking down an aisle, whether the customer is walking towards a display, among other things.

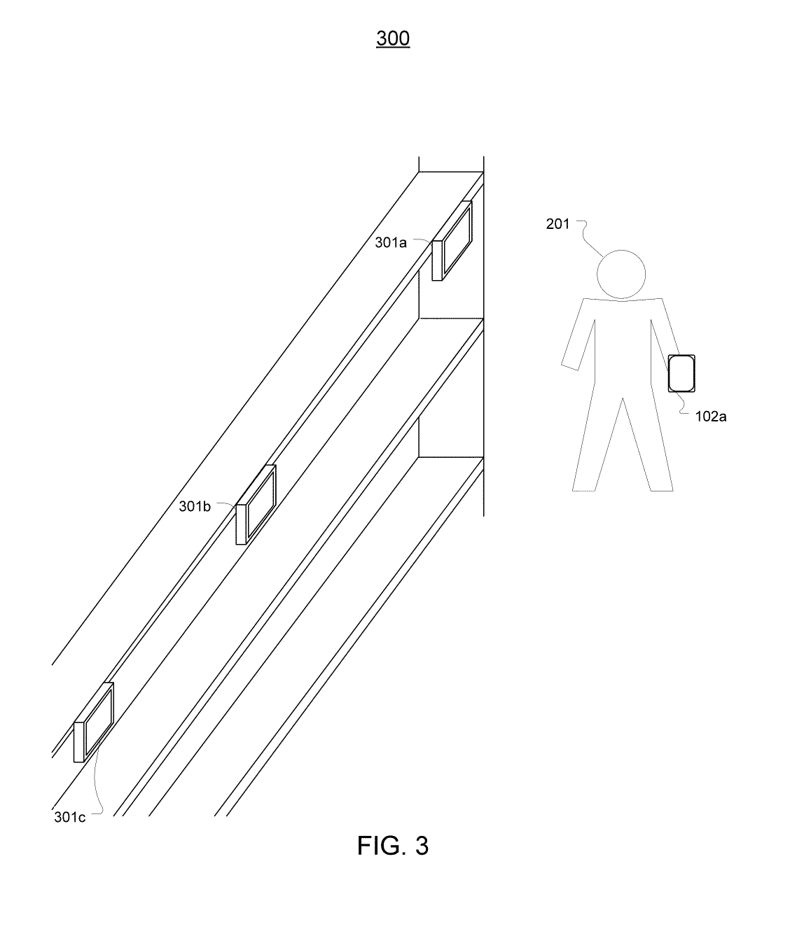

Using information obtained from user interface 200 such as which direction the customer is facing, the location where the customer is located, and an intended route through the store, various displays within the store can be dynamically updated. For example, as shown in FIG. 3, when it is determined that the customer is looking down an aisle, the displays 301a-301c in the aisle can be activated, updated, or customized in some manner. Similarly, when it is determined that the customer is facing a display or is moving towards a display, an advertisement on the display can be customized for the customer.

In some embodiments, user interface 200 can be used to locate retail stores that are within a specified proximity of the customer's current location. For example, if the customer is standing at the corner of a block and desires to know which grocery stores are within walking distance of his current location, user interface 200 can use the current location to identify all stores within a specified distance and display the stores to the customer. Similarly, user interface 200 can allow the customer to specify a specific type of store, a specific store chain, or a specific product, in response to which, user interface 200 can display stores that match the customer's criteria.

User interface 200 can be configured to store and analyze a customer's interactions with the user interface or other displays located in a store, interactions with a store website, routes taken by the customer through the store, products viewed or purchased, etc. This information can be used to customize future information provided to the customer such as advertisements, store maps, routes, suggested purchases, etc.

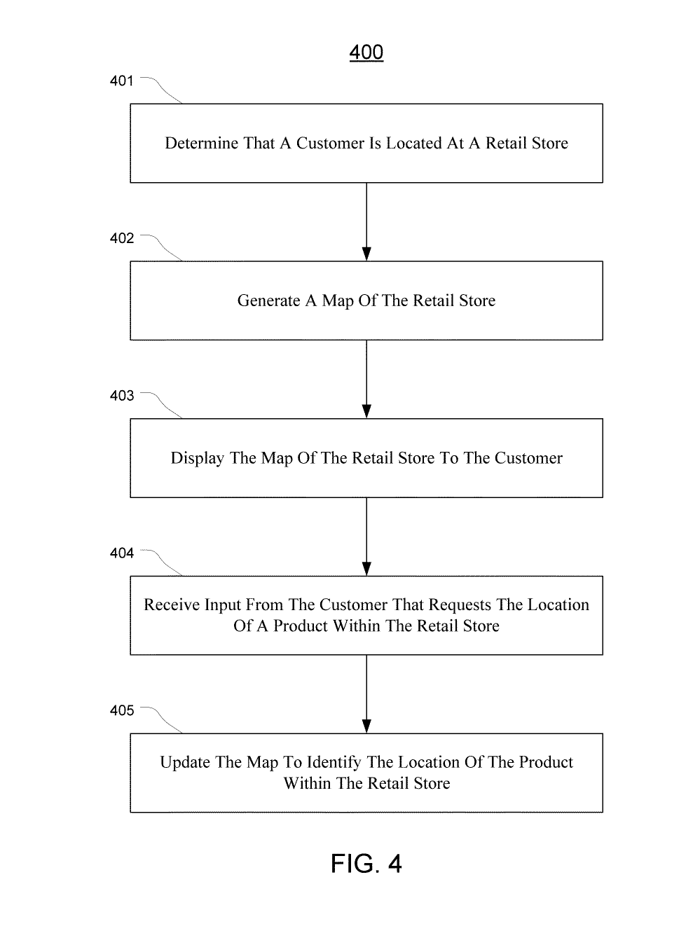

FIG. 4 illustrates a flowchart of an exemplary method 500 for providing a map of a retail store to guide a customer in the retail store. Method 400 can be implemented by a portable computing device such as a smart phone or other device having a display that is carried by the customer. Method 400 will be described with reference to the figures.

Method 400 includes an act 401 of determining that a customer is located at a retail store. For example, customer computing device 102a can determine that the customer is located at a retail store such as by using GPS coordinates, receiving a signal transmitted from a device within the retail store, receiving customer input, etc.

Method 400 includes an act 402 of generating a map of the retail store. For example, a map 201 of the retail store can be generated on customer computing device 102a.

Method 400 includes an act 403 of displaying the map of the retail store to the customer. For example, user interface 200 can display map 201 to the customer.

Method 400 includes an act 404 of receiving input from the customer that requests the location of a product within the retail store. For example, user interface 200 can receive input from customer 201 that requests the location of a product within the retail store.

Method 400 includes an act 405 of updating the map to identify the location of the product within the retail store. For example, user interface 200 can update map 201 to identify the location of the product within the retail store.

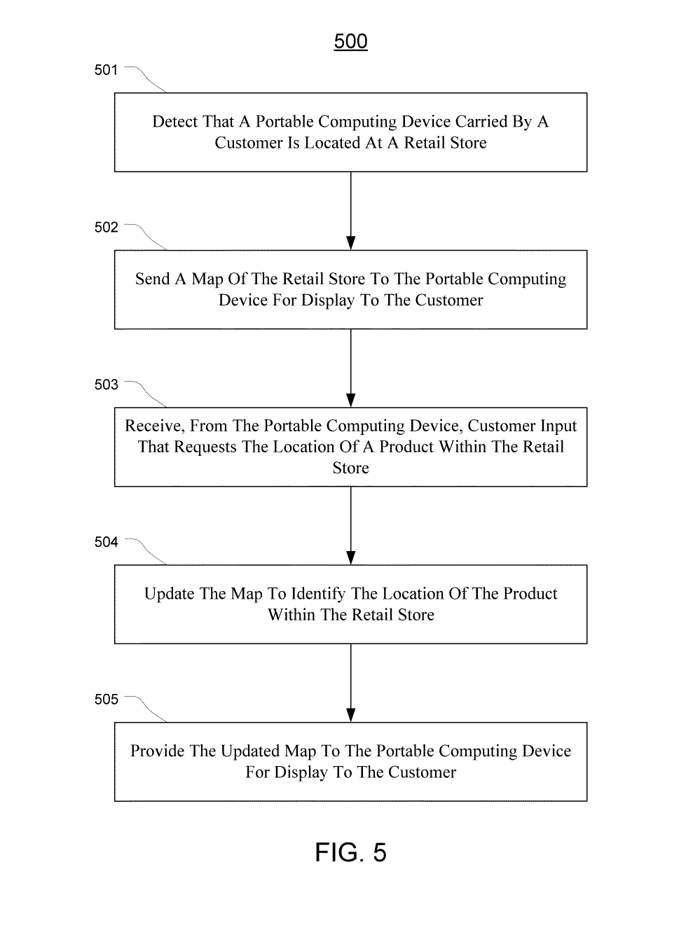

FIG. 5 illustrates a flowchart of an exemplary method 500 for providing a map of a retail store to a portable computing device carried by a customer at the retail store. Method 500 can be performed by server system 101, a computer system connected to server system 101, or another computer system that can communicate with a customer's portable computing device. For example, method 500 can be performed by a computer system located in a retail store that can communicate with a customer's mobile device and one or more other computer systems whether located in the store or outside the store. Method 500 will be described with reference to the figures.

Method 500 includes an act 501 of detecting that a portable computing device carried by a customer is located at a retail store. For example, server system 101 can receive a signal or other input from customer computing device 102a that identifies that customer computing device 102a is at a retail store.

Method 500 includes an act 502 of sending a map of the retail store to the portable computing device for display to the customer. For example, server system 101 can send a map of the retail store to customer computing device 102a.

Method 500 includes an act 503 of receiving, from the portable computing device, customer input that requests the location of a product within the retail store. For example, server system 101 can receive customer input that was received via user interface 200 being displayed on customer computing device 102a.

Method 500 includes an act 504 of updating the map to identify the location of the product within the retail store. For example, server system 101 can update the map by adding an identifier of the location of the product within the map.

Method 500 includes an act 505 of providing the updated map to the portable computing device for display to the customer. For example, server system 101 can send the updated map to customer computing device 102a for display within user interface 200.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a portable computing device, for providing a map of a retail store to guide a customer in the retail store, the method comprising:
determining, by the portable computing device, that a customer is located at a retail store;
generating a map of the retail store;
displaying the map of the retail store to the customer;
receiving input from the customer that requests the location of a product within the retail store; and
updating the map to identify the location of the product within the retail store.

2. The method of claim 1, wherein the portable computing device comprises the customer's smart phone.

3. The method of claim 1, wherein determining that the customer is located at the retail store comprises one or more of:
using GPS coordinates to determine the location; or
receiving a signal from a device located within the retail store.

4. The method of claim 1, wherein generating the map of the retail store comprises rendering a map on a display of the portable computing device.

5. The method of claim 4, wherein the map comprises a floor plan of the retail store that includes aisles and shelves.

6. The method of claim 1, further comprising:
determining a current location of the customer within the retail store; and
displaying a route from the current location to the location of the product.

7. The method of claim 1, further comprising:
receiving a shopping list from the customer; and
displaying a route through the retail store that passes each product on the shopping list.

8. The method of claim 7, wherein the route is optimized to provide the most efficient route through the retail store.

9. The method of claim 7, further comprising:
providing a time estimate for how long it will take for the customer to travel the route.

10. The method of claim 1, further comprising:
displaying advertisements to the customer based on the location of the customer within the retail store.

11. The method of claim 1, further comprising:
displaying advertisements to the customer based on products listed on a shopping list.

12. The method of claim 1, further comprising:
determining a direction the customer is facing; and
modifying a display device based on the direction.

13. The method of claim 12, wherein modifying the display device comprises updating or customizing content displayed on the display device.

14. One or more non-transitory computer readable media storing computer executable instructions which when executed implement a method for providing a map of a retail store to guide a customer in the retail store, comprising:
determining that a customer is located at a retail store;
generating a map of the retail store;
displaying the map of the retail store to the customer;
receiving input from the customer; and
based on the input, updating the map to assist the customer in locating one or more products in the retail store.

15. The one or more computer readable media of claim 18, wherein the input comprises a shopping list, and wherein updating the map comprises displaying a route through the store that passes each product on the shipping list.

16. The one or more computer readable media of claim 18, wherein the input comprises a product, and wherein updating the map comprises displaying an indication on the map that identifies where the product is located within the retail store.

17. A method, performed by a computer system, for providing a map of a retail store to a portable computing device carried by a customer at the retail store, the method comprising:
detecting that a portable computing device carried by a customer is located at a retail store;
sending a map of the retail store to the portable computing device for display to the customer;
receiving, from the portable computing device, customer input that requests the location of a product within the retail store;
updating the map to identify the location of the product within the retail store; and
providing the updated map to the portable computing device for display to the customer.

18. The method of claim 17, wherein detecting that the portable computing device carried by the customer is located at the retail store comprises receiving a signal from the portable computing device that identifies the portable computing device.

19. The method of claim 17, wherein updating the map to identify the location of the product within the retail store further comprises:
determining the current location of the portable computing device within the store;
generating a route from the current location to the location of the product; and
updating the map to include the route.

20. The method of claim 17, further comprising:
providing additional content to the portable computing device for display with the map, the additional content comprising one or more of an advertisement or information about a product.
